(19) United States
(12) Patent Application Publication
(10) Pub. No.: US 2002/0134646 A1
(43) Pub. Date: Sep. 26, 2002

(54) Conveying apparatus and a roller conveyor system

(76) Inventor: Kazuo Itoh, Kasai-shi (JP)

Correspondence Address: WOOD, PHILLIPS, VAN SANTEN,, CLARK & MORTIMER, SUITE 3800, 500 WEST MADISON STREET, CHICAGO, IL, 60661, US

(21) Appl. No.: 10/091,851

(22) Filed: Mar. 6, 2002

(30) Foreign Application Priority Data
Mar. 22, 2001 (JP) 83109/2001

(51) Int. Cl. B65G 47/10

(52) U.S. Cl. 198/370.1

(57) ABSTRACT

A conveying apparatus is composed of a motorized roller (2), cams (3), a rotation axis deflector (4), a drive pulley (5), a driven pulley (6), an endless belt (7), a flat support (8) and a spring (9). The roller (2) and the deflector (4) take their position enclosed with the belt (7), and the shaft (15) of the roller (2) is operatively connected by the deflector (4) to the drive pulley (5). A sleigh-shaped top plate (25) of the support (8) intervenes between the roller (2) and the back surface of the belt (7), and when the cylindrical casing (12) of this roller rotates, the cams (3) will also rotate to raise the support (8) and lift the upper transporting path of the belt (7), so that the apparatus is rendered so smaller in size that it can be used as a cross transporter adapted for installation in any desired space.

### BACKGROUND OF THE INVENTION

1. Field of the Invention

The present invention relates to a conveying apparatus for installation in a conveyor line that is repeatedly unloaded of or loaded with articles.

2. Description of Related Art

Usually, conveyor lines are incorporated in various assembling manufacture lines or at distribution stations wherever articles are successively transported along the lines or within the stations. For example, a number of conveyor lines may typically be arranged lengthwise and crosswise in each distribution station, with some transverse conveyors called “cross feeders” being placed at given positions. Such cross feeders will operate to transfer the articles from one conveyor line to another so as to forward them to respective destinations.

Generally, each cross feeder comprises a transporting mechanism and a lifting mechanism. The top of the transporting mechanism takes its normal position below the article-supporting surface of the longitudinal conveyor line, so as not to interfere with any article being moved on and along this conveyor line. A sensor or the like device will detect the destination of every article so that a stopper is driven to catch and temporarily hold the thus selected article on the cross feeder. Thereafter, the lifting mechanism will be turned on to raise the transporting mechanism above the article-supporting surface of the longitudinal conveyor line. The transporting mechanism will subsequently be switched on so that the selected article thus lifted moves onto an adjacent conveyor line.

One of the prior apparatuses known in the art is the “motorized roller” comprising a cylinder that encloses therein a motor accompanied by a speed reducer. This prior art apparatus is for use as the lifting mechanism in the cross feeder (see Patent Laying-Open Gazette H. 6-312832).

FIG. 4 recites the cross feeder disclosed in this Gazette H. 6-312832. This cross feeder 100 is composed of a transporting mechanism 101 and a lifting mechanism 102, wherein motorized rollers 110 and 105 serve as principal parts of the respective mechanisms 101 and 102.

The transporting mechanism 101 constituting the cross feeder shown in FIG. 4 comprises an idle roller 111 and some guide rollers 112, in addition to the motorized roller 110. Each of two belts 115 lying in parallel with each other engages with those motorized roller 110, idle roller 111 and guide rollers 112, to thereby form a loop around them.

On the other hand, the motorized roller 105 of the lifting mechanism 102 has rings 106 fixed on its outer peripheral zones. A tie link 108 has one end operatively connected by a pin 107 to the ring 106, with the tie link's other end adjoined to the transporting mechanism 101.

As will be seen in FIG. 4, the transporting mechanism 101 will remain above the transporting surface of the conveyor line so long as the pin 107 is kept at its uppermost position. When the transporting mechanism 101 is subsequently retracted below the said surface of conveyor line, the motorized roller 105 will spin a quarter of one rotation to lower this mechanism synchronously with the pin 107.

The cross feeder 100 of FIG. 4 is for use in combination with a roller conveyor line such that each belt 115 of the feeder does intervene between two adjacent rollers included in the conveyor line.

When the conveyor line is loaded with or unloaded of an article, the motorized roller 105 in the lifting mechanism 102 will operate at first. This motion is made to lift the transporting mechanism 101 until the upper traveling path of each belt 115 protrudes up between the constituent rollers of the conveyor line so as to raise the article above it. Next, the motorized roller 110 in the transporting mechanism 101 will be switched on to circulate the belts 115 over and around its rollers, thereby removing the article from the conveyor line.

### SUMMARY OF THE INVENTION

As described above, each of the two parallel belts 115 of the prior art cross feeder is intended for insertion in between the two adjacent rollers of a conveyor. It is however to be noted that a distance between the adjacent rollers is not necessarily constant but largely varies between the types of roller conveyors. Thus, it has been difficult in some cases to properly dispose each belt among the rollers.

Further, the prior art cross feeder is composed of two discrete sections, that is the transporting and lifting mechanisms 101 and 102. This structure has rendered the feeder considerably large in its overall size, to such an extent as possibly disabling the cross feeder to be installed in a requisite portion of the conveyor line.

An object of the present invention made in view of the drawbacks inherent in the prior art is therefore to develop and provide a transversely conveying apparatus rendered smaller in size and capable of installation into any narrow space.

A conveying apparatus provided herein to achieve the object does comprise a motor-installed cylindrical device comprising a cylindrical casing having opposite ends, a motor accompanied by a speed reducer and accommodated in the cylindrical casing together with the reducer, and a shaft whose at least one end protrudes outwards from at least one end of the cylindrical casing. This casing is capable of rotating relative to and about the shaft, and the shaft is also capable of rotating about a rotation axis so as to produce a torque. The apparatus further comprises at least one cam fixed on the casing, an endless member, a drive member for driving the endless member, a terminal member disposed opposite to the drive member, and a deflector for converting the rotation axis to a transverse axis for the drive member. The transverse axis extends crosswise, preferably substantially perpendicular, to the rotation axis so as to transmit the torque to the drive member. In this apparatus, the drive member and the terminal member are spanned with the endless member that substantially encloses the motor-installed cylindrical device. The apparatus still further comprises a support that is interposed between the cylindrical casing and the endless member so as to be capable of contacting both the at least one cam and the endless member. When the shaft rotates relative to the cylindrical casing standing stationary, the torque will be applied to the drive member so as to cause the endless member to travel in a circulating manner. If contrarily the cylindrical casing rotates together with the cam relative to the shaft standing still, then the cam will raise or lower the support so as to expand outwards or retract inwards a portion of the endless member.

From another aspect of the invention, it provides a conveying apparatus that comprises a motor-installed device having opposite ends, the device comprising a main body holding therein the motor and a shaft whose at least one end protrudes outwards from at least one end of the main body. This main body is capable of rotating relative to and about the shaft, and the shaft is also capable of rotating about a rotation axis so as to produce a torque. The apparatus further comprises at least one cam fixed on the main body of the motor-installed device, an endless member, a drive member for driving the endless member, a terminal member disposed opposite to the drive member, and a deflector for converting the rotation axis to a transverse axis for the drive member. The transverse axis extends crosswise, preferably substantially perpendicular, to the rotation axis so as to transmit the torque to the drive member. In this apparatus, the drive member and the terminal member are spanned with the endless member that substantially encloses the motor-installed device. The apparatus still further comprises a support capable of contacting the endless member. When the shaft rotates relative to the main body standing stationary, the torque will be applied to the drive member so as to cause the endless member to travel in a circulating manner. When however the main body rotates together with the cam relative to the shaft standing still, the cam will raise or lower the support so as to expand outwards or retract inwards a portion of the endless member.

The motor-installed device in the apparatus just summarized above may be a type of motorized roller that includes a cylindrical casing holding therein a motor and a speed reducer. At least one end of the shaft protrudes outwards from at least one end of the cylindrical casing. The casing is rotatable relative to the shaft.

The support may intervene between the motorized roller and the endless member so as to contact both the cam and this member.

In the conveying apparatus from either aspect of the invention, all the principal parts take their position to be enclosed by the endless member. The apparatus thus rendered much smaller in its overall size as compared with the prior art ones can now be incorporated in any desired space, broad or narrow.

Preferably, the endless member noted above may be a belt and both the drive and terminal members may be a pulley. The endless member may otherwise be a chain cooperating with sprockets employed as the drive and terminal members.

Also preferably, the terminal member is movable towards and away from the drive member.

Thus, distance between the rotation axes of those drive and terminal members is variable so that tension appearing in and along the endless member stands constant, not affected by the ascending or descending movement of the support.

It also is desirable to provide the apparatus with a braking means that will force the cylindrical casing not to spin but to stand still. In this case, the endless member will start to travel in a circulating manner upon stoppage of the cylindrical casing braked by said means.

The motor-installed cylindrical device used in the apparatus described above is constructed such that its cylindrical casing and its shaft do rotate relative to each other.

The conveying apparatus of the invention may be incorporated in a roller conveyor system in such a fashion that each apparatus is arranged in between two adjacent ones of parallel rotatable rollers constituting the system.

Therefore, from still another aspect of the invention, it provides a roller conveyor system composed of rollers arranged side by side and rotating about axes thereof and at least one transverse conveying apparatuses each interposed between the adjacent two rollers, wherein each transverse conveying apparatus comprises a motor-installed cylindrical device comprising a cylindrical casing having opposite ends, a motor accompanied by a speed reducer and accommodated in the cylindrical casing together with the reducer, and a shaft whose at least one end protrudes outwards from at least one end of the cylindrical casing. This casing is capable of rotating relative to and about the shaft, and the shaft is also capable of rotating about a rotation axis so as to produce a torque. The apparatus further comprises at least one cam fixed on the casing, an endless member, a drive member for driving the endless member, a terminal member disposed opposite to the drive member, and a deflector for converting the rotation axis to a transverse axis for the drive member. The transverse axis extends crosswise, preferably substantially perpendicular, to the rotation axis so as to transmit the torque to the drive member. In this apparatus, the drive member and the terminal member are spanned with the endless member that substantially encloses the motor-installed cylindrical device. The apparatus still further comprises a support that is interposed between the cylindrical casing and the endless member so as to be capable of contacting both the at least one cam and the endless member. When the shaft rotates relative to the cylindrical casing standing stationary, the torque will be applied to the drive member so as to cause the endless member to travel in a circulating manner. If however the cylindrical casing rotates together with the cam relative to the shaft standing still, then the cam will raise or lower the support so as to expand outwards or retract inwards a portion of the endless member.

### BRIEF DESCRIPTION OF THE DRAWINGS

FIG. 1 is an exploded perspective view of a conveying apparatus provided in an embodiment of the present invention and having a flat support built therein;

FIG. 2(a) is a longitudinal and vertical cross section of the apparatus shown in FIG. 1, with the support being at its lowered home position;

FIG. 2(b) is a transverse and vertical cross section of the apparatus shown in FIG. 1, with the support being at the home position;

FIG. 2(c) is a longitudinal and vertical cross section of the apparatus also shown in FIG. 1, but with the support being at its raised operative position;

FIG. 2(d) is a transverse and vertical cross section of the apparatus shown in FIG. 1, with the support being at the operative position;

FIG. 3 is a perspective view of a roller conveyor system using the conveying apparatuses incorporated therein in another embodiment; and

FIG. 4 is a perspective view of the prior art cross feeder.

### DESCRIPTION OF THE PREFERRED EMBODIMENTS

Now some embodiments of the invention will be described referring to the drawings as summarized above.

The reference numeral 1 in the drawing figures denotes a conveying apparatus or apparatuses. Each apparatus comprises a motorized roller (viz., a motor-installed cylindrical device) 2, cams 3 and a deflector 4 for changing the directions of rotation axes one to the other. The apparatus further comprises a drive pulley (serving as the self-spinning drive member) 5, a driven pulley (as the terminal member) 6, and endless belt 7, a flat support 8 and a spring 9.

The motorized roller 2 is available on the market and may for instance be a “POWER MOLLER”, which is the trademark of one type products sold by the Itoh Electric Co., Ltd. Its cylindrical casing 12 holds therein a motor (not shown) and a speed reducer (not shown) substantially consisting of a planetary gear train. Ends of shafts 15, 16 protrude sideways from opposite ends of the cylindrical casing 12. The shafts 15, 16 may be in one piece each with the other or be discrete members. The motorized rollers 2 are employed as the constituent rollers in a usual type roller conveyor system, with the ends of shafts 15, 16 being fixed on the frame of said conveyor system. An electric current supplied to the motor will drive and rotate the cylindrical casing 12 enclosing this motor. The motorized roller 2 is constructed such that power supply to the motor causes the casing to spin, if the ends of shafts 15, 16 are restrained from rotation. In other words, due to power supply to the motor, the casing 12 does in one occasion rotate relative to the shaft of the motorized roller 2. This means that the shafts 15, 16 will however be forced to rotate in another occasion that the casing 12 is prevented from spinning about its axis.

The disc-shaped cams 3, the number of them being two (2) herein, are rigidly and firmly secured on the outer periphery of cylindrical casing 12 of motorized roller 2. The center of each cam 3 is offset from that of the casing 12 so that the former will make an eccentric rotation when the latter spins.

The deflector 4 for changing rotation axes is constructed such that rotation of one member about its axis is transmitted to the other member, causing it to spin about the other axis intersecting the first-mentioned axis. In detail, this deflector 4 causes the rotation axis of the output side member to be perpendicular to that of the input side member. In the present embodiment, a bevel friction wheel 20, an intermediate friction wheel 22 and an annular groove 23 formed in the driving pulley 5 do cooperate to constitute such a deflector 4.

The endless belt 7 may be made of a rubber or a plastics.

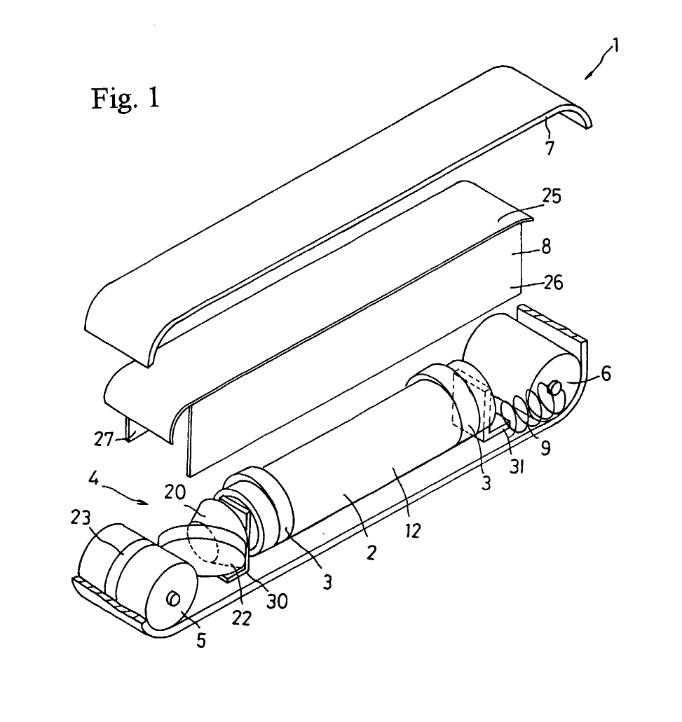

The support 8 is of a box-like shape consisting of a top plate 25 and a pair of right and left side walls 26 and 27. The top plate 25 looks like a sleigh, but its opposite ends are curved downwards to be arcuate as shown in FIG. 1.

Relationships in operation between the parts and members summarized above are as follows.

The motorized roller 2 is fixed on a frame not shown by means of brackets 30 and 31, which supports the respective ends of shafts 15, 16 protruding from said roller 2 so as to allow said shafts to rotate.

The drive pulley 5 and the driven pulley 6 are disposed on the opposite ends of the motorized roller 2, with the shaft thereof extending at a right angle with respect to those of said pulleys.

The drive and driven pulleys 5 and 6 are rotatably supported by frame members not shown, and the driven pulley 6 can move a permissible distance towards and away from the drive pulley 5. In other words, the spacing between those pulleys is changeable during operation of this apparatus.

Interposed between the end of the shaft 15 of the motorized roller 2 and the drive pulley 5 is the rotation axis deflector 4, wherein the end of the shaft 15 is operatively connected to the bevel friction wheel 20 of the deflector. The intermediate wheel 22 is in a frictional contact with both the friction surface of the bevel wheel 20 and the annular groove 23 of the drive pulley 5.

The spring 9 urges always the shaft of driven pulley 6 away from that of the drive pulley, thereby biasing the spacing between those pulleys to increase.

The support 8 generally covers the motorized roller 2, such that the sleigh-shaped top plate 25 of the support overlies this motorized roller, with the side walls 26 and 27 of said plate covering the sides of said roller.

The drive pulley 5 and driven pulley 6 are spanned with the endless belt 7.

Among the parts and members assembled as described above, the motorized roller 2 and the rotation axis deflector 4 take their position surrounded by the endless belt 7, with the end of the shaft 15 of said roller being connected by the deflector 4 to the drive pulley 5.

The sleigh-shaped top 25 of the support 8 intervenes between the motorized roller 2 and the back surface of endless belt 7.

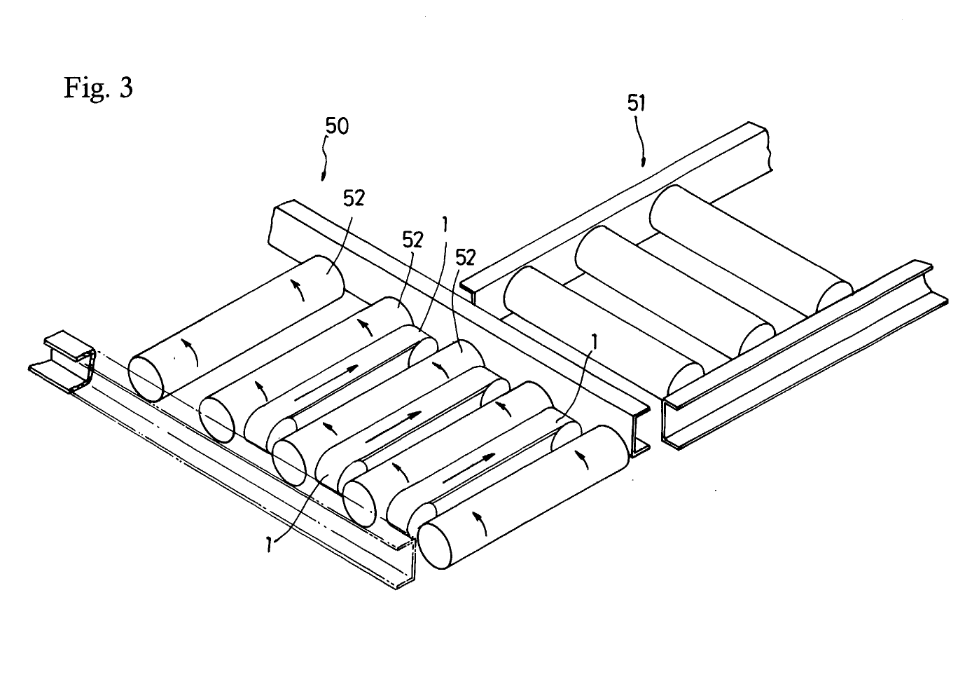

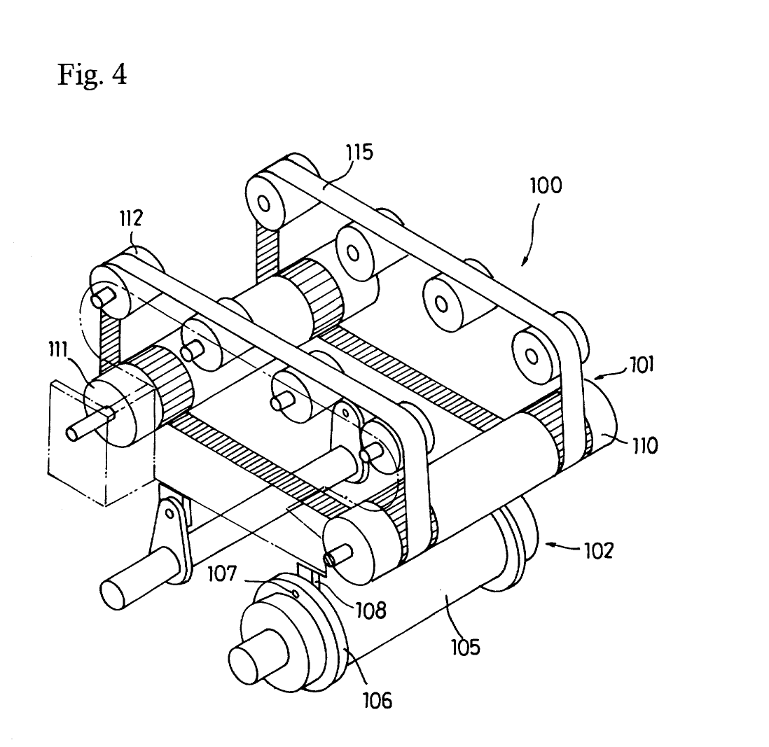

As shown in FIG. 3, the conveying apparatuses 1 are disposed at the junction where a branch line 51 diverges from a main conveyor line 50 to form a roller conveyor system. The main line 50 comprise a plurality of motorized rollers 52 arranged side by side to provide spaces each between two adjacent rollers, so that in the illustrated embodiment three conveying apparatuses 1 respectively fit in the corresponding three of such spaces included in the junction.

Each of the conveying apparatuses 1 is of an overall width substantially equal to width of the endless belt 7, whereby each apparatus can be disposed easily and snugly in one of those spaces between the two adjacent rollers 52 in the conveyor line 50.

Since overall height of the conveying apparatus is low enough to enable installation thereof even in a considerably narrow space left under the row of rollers in the conveyor line 50.

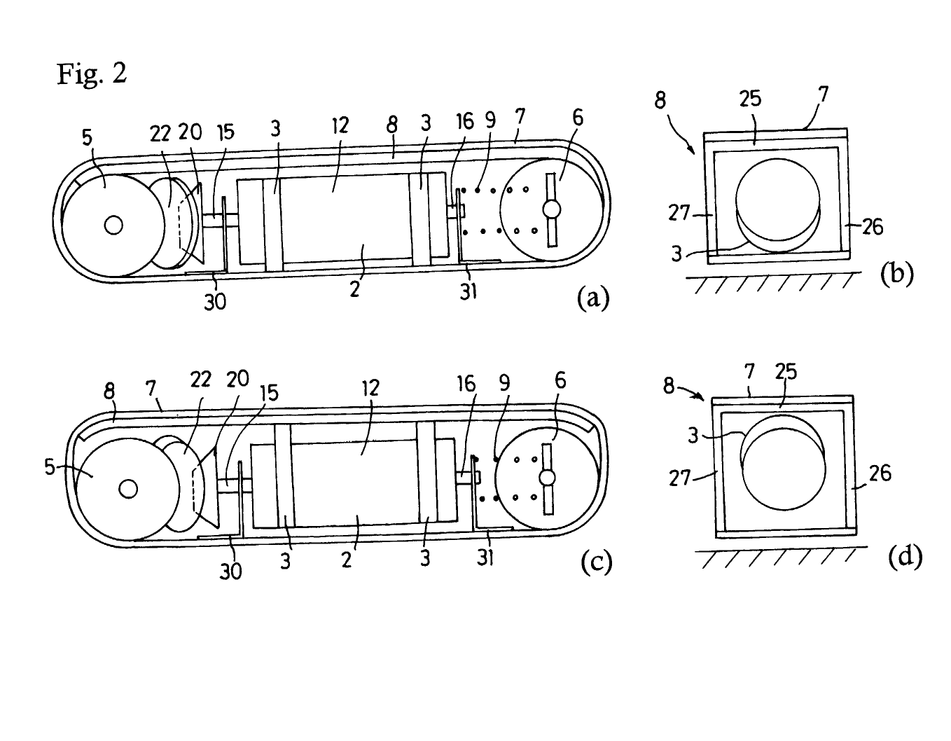

The conveying apparatus 1 in this embodiment is disposed in one of those spaces between the two adjacent rollers 52, as described above. In their normal state, each cam 3 of the apparatus intervening between the rollers 52 has its protuberance taking a lowermost position, and the sleigh-shaped top 25 of the support 8 is at its lower dead point, as shown in FIGS. 2(a) and 2(b).

In operation, as an article for delivery to the branch line 51 advances forwards and arrives at the junction of the conveyor line 50, the motor installed in the roller 2 will be activated with an electric current. Consequently, the cylindrical casing 12 of the motorized roller 2 starts to spin together with the cams 3 fixed thereon. Those cams will thus abut against the inner surface of sleigh-shaped top 25 of the support 8, to thereby urge it upwards until said top lifts the upper traveling path of the endless belt 7. It is to be noted here that the driven pulley 6 has its shaft capable of displacement towards and away from the shaft of drive pulley 5, as already discussed above. Thanks to this feature, as the support 8 pushes up the upper path of the belt 7, the driven pulley 6 will gradually move toward the drive pulley against resilient force of the spring 9, so as to smoothly lift said upper path.

In short, the cylindrical casing 12 of the motorized roller 2 rotates in a spinning manner to cause the cams 3 to urge up the support 8, which in turn will expand the belt 7 in part. The thus raised upper path of said belt will be exposed above the plane in which the tops of motorized rollers 52 are included, thereby picking up the article.

Upon arrival of the support 8 at its upper dead point, a forcible braking means (detailed below) stops the cams not to rotate any more. The cylindrical casing 12 of the motorized roller 2 will consequently be forced to cease its rotation. Because said casing 12 and the shafts 15, 16 are designed to rotate relative to each other, the casing thus stopped will force the shafts 15, 16 to commence their rotation. As a result, the torque of the shaft is transmitted through the deflector 4 to the drive pulley 5 so that the latter begins rotation to initiate the circulating movement of the belt 7. The article at the junction on the conveyor line 50 will be driven in this manner to move sideways and transfer to the branch line 51.

Upon completion of the article transfer, the motorized roller 2 will be activated to turn in a reversed direction so that the support 8 is lowered to retract the upper path of endless belt under the plane including all the tops of motorized rollers 52 in the conveyor line 50.

In the embodiment detailed above, a belt is employed as the endless member and pulleys serve as the means for driving the belt. However, an endless chain and sprockets may substitute for such a belt and pulleys.

The embodiment has exemplified the rotation axis deflector 4 to consist of the bevel friction wheel 20, intermediate friction wheel 22 and annular groove 23 in the drive pulley 5. Such a frictional transmission is intended to relieve any overload that would injure the parts. The intermediate wheel 22 will absorb fluctuation of the motorized roller 2 and/or drive pulley 5, because loose fitting and/or dimensional error of the relevant parts would possibly cause slight idle motions thereof. If such a looseness and error are merely of a negligible degree, then bevel wheels or a worm/worm gear assembly may be employed.

Although the uppermost position of the support 8 triggers the braking and stopping of the casing 12 in the foregoing embodiment, any other proper means may be used to temporarily restrain the casing at its stationary position.

It will now be apparent that all the principal parts of the conveying apparatus of the present invention are covered with the endless member, whereby the apparatus is now effectively rendered compact and adapted for installation in any desired space.

The variable distance between the terminal member and the spinning drive member is effective to keep constant the tension of endless member, without being affected by the ascending and descending motion of the support.

Further, the forcible means having a basal end fixed on the frame not shown (similarly to the brackets 30, 31 and pulleys 5, 6) is employed herein for stopping rotation of the cylindrical casing and compelling the shaft to spin. Such a forcible braking means (operating like a brake as used in any ordinary planetary gear apparatus in order to restrain one of its two outputs) contributes to simplification in structure of the apparatus which the present invention provides.

The roller conveyor system also provided herein is not only useful in unloading the conveyor line of articles in a transverse direction, but also in loading sideways the conveyor line with the articles.

1. A conveying apparatus comprising:
a motor-installed cylindrical device comprising a cylindrical casing having opposite ends, a motor accompanied by a speed reducer and accommodated in the cylindrical casing together with the reducer;
a shaft whose at least one end protrudes outwards from at least one end of the cylindrical casing;
the casing being capable of rotating relative to and about the shaft;
the shaft being capable of rotating about a rotation axis so as to produce a torque;
at least one cam fixed on the casing;
an endless member;
a drive member for driving the endless member;
a terminal member disposed opposite to the drive member;
a deflector for converting the rotation axis to a transverse axis for the drive member, with the transverse axis extending crosswise to the rotation axis so as to transmit the torque to the drive member;
the drive member and the terminal member being spanned with the endless member that substantially encloses the motor-installed cylindrical device; and
a support that is disposed between the cylindrical casing and the endless member so as to be capable of contacting both the at least one cam and the endless member,
wherein when the shaft rotates relative to the cylindrical casing standing stationary, the torque is applied to the drive member so as to cause the endless member to travel in a circulating manner, and when the cylindrical casing rotates together with the cam relative to the shaft standing still, the cam raises or lowers the support so as to expand outwards or retract inwards a portion of the endless member.

2. A conveying apparatus as defined in claim 1, wherein the endless member is a flexible member selected from the group consisting of a belt and a chain, and both the drive member and the terminal member are parts selected from the groups consisting of pulleys and sprockets.

3. A conveying apparatus as defined in claim 1, wherein the terminal member is capable of displacement towards and away from the drive member.

4. A conveying apparatus as defined in claim 1, further comprising a braking means for forcing the cylindrical casing not to spin but to stand still, so that the endless member starts to travel in a circulating manner upon stoppage of the cylindrical casing braked by said means.

5. A conveying apparatus as defined in claim 1, wherein the deflector comprises a bevel friction wheel and an intermediate friction wheel.

6. A conveying apparatus as defined in claim 1, wherein the support has a top plate and side walls so as to cover the motor-installed cylindrical device.

7. A conveying apparatus as defined in claim 1, wherein the support has arcuate ends.

8. A conveying apparatus comprising:
a motor-installed device having opposite ends and comprising a main body holding therein the motor and a shaft whose at least one end protrudes outwards from at least one end of the main body;
the main body being capable of rotating relative to and about the shaft;
the shaft being also capable of rotating about a rotation axis so as to produce a torque;
at least one cam fixed on the main body of the motor-installed device;
an endless member;
a drive member for driving the endless member;
a terminal member disposed opposite to the drive member;
a deflector for converting the rotation axis to a transverse axis for the drive member, with the transverse axis extending crosswise to the rotation axis so as to transmit the torque to the drive member;
the drive member and the terminal member being spanned with the endless member that substantially encloses the motor-installed device; and
a support capable of contacting the endless member,
wherein when the shaft rotates relative to the main body standing stationary, the torque is applied to the drive member so as to cause the endless member to travel in a circulating manner, and when the main body rotates together with the cam relative to the shaft standing still, the cam raises or lowers the support so as to expand outwards or retract inwards a portion of the endless member.

9. A conveying apparatus as defined in claim 8, wherein the motor-installed device comprises a cylindrical casing holding therein a motor and a speed reducer and the shaft whose at least one end protrudes outwards from the cylindrical casing, wherein the casing is rotatable relative to the shaft so as to form as a whole a type of a motorized roller.

10. A conveying apparatus as defined in claim 8, wherein the support is disposed between the cylindrical casing and the endless member so as to be capable of contacting both the cams and the endless member.

11. A conveying apparatus as defined in claim 8, wherein the endless member is a flexible member selected from the group consisting of a belt and a chain, and both the drive member and the terminal member are parts selected from the groups consisting of pulleys and sprockets.

12. A conveying apparatus as defined in claim 8, wherein the terminal member is capable of displacement towards and away from the drive member.

13. A conveying apparatus as defined in claim 8, further comprising a braking means for forcing the cylindrical casing not to spin but to stand still, so that the endless member starts to travel in a circulating manner upon stoppage of the cylindrical casing braked by said means.

14. A conveying apparatus as defined in claim 8, wherein the deflector comprises a bevel friction wheel and an intermediate friction wheel.

15. A conveying apparatus as defined in claim 8, wherein the support has a top plate and side walls so as to cover the motor-installed cylindrical device.

16. A conveying apparatus as defined in claim 8, wherein the support has arcuate ends.

17. A roller conveyor system comprising rollers arranged side by side and rotating about axes thereof and at least one transverse conveying apparatuses each interposed between the adjacent two rollers, each transverse conveying apparatus comprising:
a motor-installed cylindrical device comprising a cylindrical casing having opposite ends, a motor accompanied by a speed reducer and accommodated in the cylindrical casing together with the reducer, and a shaft whose at least one end protrudes outwards from at least one end of the cylindrical casing;
the casing being capable of rotating relative to and about the shaft;
the shaft also being capable of rotating about a rotation axis so as to produce a torque;
at least one cam fixed on the casing;
an endless member;
a drive member for driving the endless member;
a terminal member disposed opposite to the drive member;
a deflector for converting the rotation axis to a transverse axis for the drive member, the transverse axis extending crosswise to the rotation axis so as to transmit the torque to the drive member;
the drive member and the terminal member being spanned with the endless member that substantially encloses the motor-installed cylindrical device; and
a support that is interposed between the cylindrical casing and the endless member so as to be capable of contacting both the at least one cam and the endless member, wherein when the shaft rotates relative to the cylindrical casing standing stationary, the torque is applied to the drive member so as to cause the endless member to travel in a circulating manner, and when the cylindrical casing rotates together with the cam relative to the shaft standing still, the cam raises or lowers the support so as to expand outwards or retract inwards a portion of the endless member.

18. A roller conveyor system as defined in claim 17, wherein the motor-installed device comprises the motor, a speed reducer and a cylindrical casing holding therein the motor and the reducer, and casing is rotatable relative to the shaft so as to form as a whole a type of motorized roller.

19. A roller conveyor system as defined in claim 17, wherein the support is disposed between the cylindrical casing and the endless member so as to be capable of contacting both the cams and the endless member.

20. A roller conveyor system as defined in claim 17, wherein the endless member is a flexible member selected from the group consisting of a belt and a chain, and both the drive member and the terminal member are parts selected from the groups consisting of pulleys and sprockets.

21. A roller conveyor system as defined in claim 17, wherein the terminal member is capable of displacement towards and away from the drive member.
